(19) United States
(12) Patent Application Publication
(10) Pub. No.: US 2026/0200118 A1
(43) Pub. Date: Jul. 16, 2026

(54) Bread slicer with a guiding surface

(71) Applicant: JAC S.A., Liège (BE)

(72) Inventor: Baudouin Van Cauwenberghe, Liège (BE)

(21) Appl. No.: 19/326,949

(22) Filed: Sep. 12, 2025

(30) Foreign Application Priority Data
Sep. 12, 2024 (BE) 2024/5616

(51) Int. Cl. B26D 7/32

(52) U.S. Cl. CPC B26D 7/32; B26D 2007/327; B26D 2210/06

(57) ABSTRACT

A bread slicer including a loading compartment, which is connected to a receiving compartment, the compartments defining a chute for moving the loaf of bread, a cutting member for slicing the loaf of bread, a support surface for the loaf of bread, a side wall for the chute with a first part of the wall extending along the loading compartment and a second part of the wall extending along the receiving compartment, a second slot extending between the compartments to allow the cutting member to pass through. The second part of the wall extends in line with the first part of the wall and the first part is connected to a guide surface which extends between the first part and the second slot so that the guide surface forms a widening of the chute which guides the loaf of bread.

The invention relates to a bread slicer for cutting bread into slices. This slicer comprises a loading compartment that is connected to a receiving compartment. These compartments define a chute to allow the loaf of bread to move through the slicer.

The slicer has a cutting blade that moves along a cutting plane to cut successive slices of the loaf of bread as it is moved between the loading and receiving compartments along the chute.

A loaf of bread to be sliced is moved on a support surface that extends in said compartments along the chute and that has a first slot between the compartments to allow the cutting blade to pass through.

Said chute is bounded laterally by a wall extending in the direction of movement of the loaf of bread. A first part of this wall extends along the loading compartment, while a second part of the wall extends along the receiving compartment. The wall has a second slot between the compartments to allow the cutting blade to pass through along the cutting plane. This second slot is connected to the first slot.

To slice a loaf of bread in this slicer, the loaf of bread is moved from the loading compartment to the receiving compartment and then moved back to the loading compartment, and, gradually, as it enters the latter compartment, the loaf of bread is sliced.

Such slicers have already been described, for example, in documents EP 3 102 376, DE 10 2014 011 167, and EP 3 347 178.

Document EP 3 102 376 discloses a slicer in which a loaf of bread is moved in a substantially horizontal direction between the loading compartment and the receiving compartment. In order to facilitate the movement of a loaf of bread between the two compartments, they can be moved laterally relative to each other. In document DE 10 2014 011 167, a guide is applied to the wall of the chute to avoid having to move the compartments laterally relative to each other to allow the loaf of bread to be moved.

Document EP 3 347 178 describes a slicer that is particularly interesting when the support surface extends vertically or approximately vertically.

Bread slicers of this type have, among other things, the disadvantage that the loaf of bread loses contact with the wall when it passes from the loading compartment to the receiving compartment due to the offset between the two compartments. The same applies to the slicer in document DE 10 2014 011 167 when there is a guide in the loading compartment.

The loss of contact between the loaf of bread and the second part of the wall extending into the receiving compartment allows the loaf of bread to move under the pressure of the cutting blade during slicing, which negatively affects the quality of the slices and the proper gripping of the loaf of bread by the pusher.

The invention aims to remedy this problem by providing a bread slicer in which a loaf of bread can be moved from the loading compartment to the receiving compartment while maintaining contact between the wall and the loaf of bread without the risk of the loaf of bread catching on the edge of the wall adjacent to the slot between the two compartments. The invention also prevents the sliced loaf of bread from catching on the edge of the part of the wall extending into the loading compartment when the loaf of bread is moved back into this loading compartment. All this while maintaining an offset between the two compartments at the slot to ensure good quality cutting of the bread slices.

To this end, in the slicer according to the invention, at least at the location of the second slot, the second part of the wall extends in line with the first part of this wall, and the first part of the wall is connected to a guide surface that extends between this first part of the wall and the second slot. This guide surface forms a widening of the chute which allows to guide the loaf of bread, in particular the slices of bread, as it moves from the receiving compartment to the loading compartment.

Advantageously, the guide surface is inclined relative to the plane of the first part of the wall.

According to a particular embodiment of the invention, the guide surface is in the form of a slat inclined relative to the support surface.

According to an interesting embodiment of the invention, the slicer comprises a movable pusher that can move in the direction of movement of the loaf of bread. This pusher allows the loaf of bread to be gripped and moved between said compartments across the cutting plane.

In a preferred embodiment of the invention, said wall extends substantially transversely to the support surface.

Interestingly, the support surface for the loaf of bread comprises a portion extending into the loading compartment and a portion extending into the receiving compartment. These portions are aligned with each other at the location of the first slot. Between the first part of the support surface and the first slot, a sliding surface is present in the loading compartment that connects to the edge of the first part of the support surface. This sliding surface faces the cutting plane and is recessed relative to the plane of the support surface.

Further details and features of the invention will be apparent from the following description, given by way of example and not limitation, of some particular embodiments of the machine and method according to the invention with reference to the accompanying drawings.

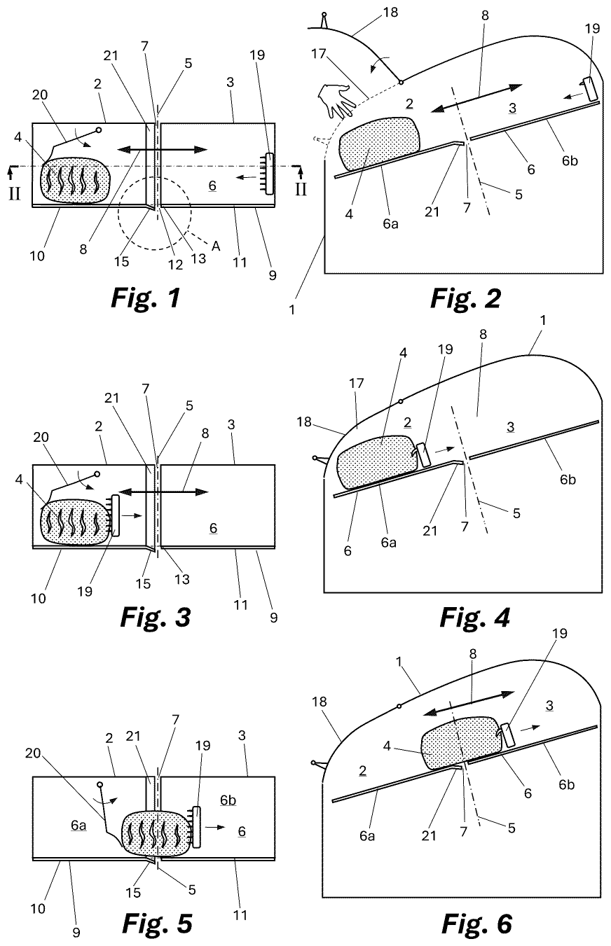

FIG. 1 is a schematic top view of a bread slicer according to the invention, in which a loaf of bread is placed in the receiving compartment.

FIG. 2 is a schematic cross-section along line II-II of the slicer in FIG. 1.

FIG. 3 is a schematic top view similar to that of FIG. 1 when the loaf of bread is gripped by the slicer's pusher.

FIG. 4 is a schematic cross-section along line IV-IV of the slicer in FIG. 3.

FIG. 5 is a schematic top view similar to that of FIG. 1 when the loaf of bread is moved across the cutting plane from the loading compartment to the receiving compartment.

FIG. 6 is a schematic cross-section along line VI-VI of the slicer in FIG. 5.

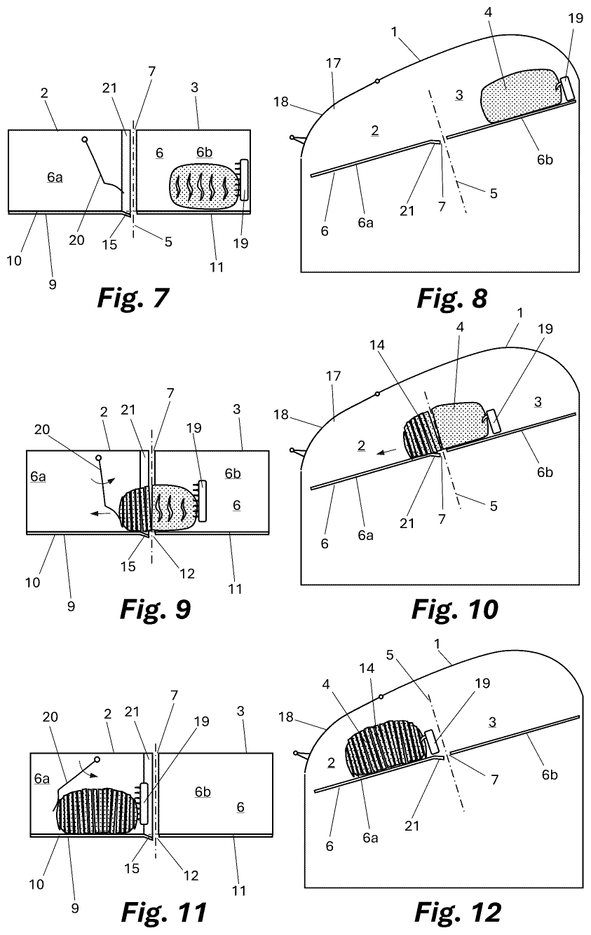

FIG. 7 is a schematic top view similar to that of FIG. 1 when the loaf of bread is in the receiving compartment.

FIG. 8 is a schematic cross-section along line VIII-VIII of the slicer in FIG. 7.

FIG. 9 is a schematic top view similar to that of FIG. 1 when the loaf of bread is moved from the receiving compartment to the loading compartment.

FIG. 10 is a schematic cross-section along line X-X of the slicer in FIG. 9.

FIG. 11 is a schematic top view similar to that of FIG. 1 when the sliced loaf of bread is in the loading compartment together with the pusher.

FIG. 12 is a schematic cross-section along line XII-XII of

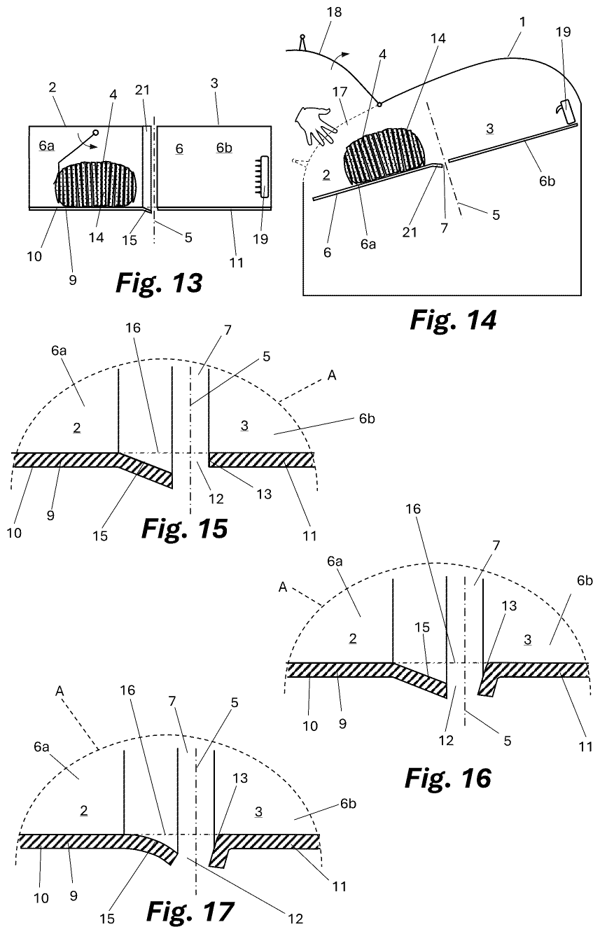

FIG. 13 is a schematic top view similar to that of FIG. 1 when the sliced loaf of bread is in the loading compartment together with the pusher and the pusher is returned to the receiving compartment.

FIG. 14 is a schematic cross-section along line XIV-XIV of the slicer in FIG. 13.

FIG. 15 shows a detail of the slicer, according to the invention, indicated by a dotted circle A in FIG. 1.

FIG. 16 shows the detail of the slicer of FIG. 15 according to an alternative embodiment of the invention.

FIG. 17 shows the detail of the slicer in FIG. 15 according to another embodiment of the invention.

In the various figures, the same reference numbers refer to similar or identical elements.

The invention generally relates to an automatic bread slicer in which a loaf of bread to be sliced is moved in a direction of movement. During this movement, slices are cut one after the other in a direction transverse to the direction of movement. This slicer includes a frame with a loading compartment and a receiving compartment. To slice a loaf of bread, a user places the loaf to be sliced in the loading compartment. The loaf of bread is then moved to the receiving compartment and returned from the receiving compartment to the loading compartment. As the loaf of bread enters the loading compartment, it is sliced. Once it has been completely sliced, the loaf is removed from the loading compartment by the user.

In another embodiment of the bread slicer, it is also possible to place the loaf of bread directly into the receiving compartment. It is then sliced while being moved to the loading compartment and returned to the receiving compartment after being sliced. The user can then remove the sliced loaf of bread from the receiving compartment.

FIGS. 1 to 14 show an interesting embodiment of a bread slicer, according to the invention, and the various stages of cutting a loaf of bread when using this slicer.

This slicer comprises a frame 1 in which a loading compartment 2 and a receiving compartment 3 are provided. These compartments 2 and 3 are connected to each other so as to form a chute to allow a loaf of bread 4 to be moved along this chute.

A cutting member is provided which is movable along a cutting plane 5 extending between the loading compartment 2 and the receiving compartment 3. Thus, this cutting member allows slices to be cut of a loaf of bread 4 when the loaf of bread 4 is moved between the loading compartment 2 and the receiving compartment 3 along the chute. The cutting member comprises, for example, a cutting blade or a circular blade which is driven around its central axis and which can undergo a back-and-forth movement along the cutting plane 5. Generally, the central axis of a circular blade extends perpendicularly to the cutting plane 5.

Compartments 2 and 3 have a bottom formed by a support surface 6 for the loaf of bread 4. This surface extends in both compartments 2 and 3 along the chute and has a first slot 7 that extends between the two compartments 2 and 3. The slot 7 delimits the receiving compartment 3 from the loading compartment 2. The presence of this first slot 7 allows the cutting member to pass through the support surface 6 along the cutting plane 5.

The support surface 6 defines a direction of movement 8 for the loaf of bread parallel to this support surface 6 and substantially transversely to the first slot 7.

The chute is bounded laterally by a wall 9. This wall 9 extends along said direction of movement 8, with a first part 10 of the wall extending along the loading compartment 2 and a second part 11 extending along the receiving compartment 3. The wall 9 also has a second slot 12 which is provided between the compartments 2 and 3 to allow the cutting member to pass through. The cutting plane 5 therefore also extends along this second slot 12 which is connected to the first slot 7. Preferably, the wall 9 extends substantially transversely with respect to the support surface 6.

The first part 10 and the second part 11 of this wall 9 extend in line with each other, at least at the location of the second slot 12. In this way, a loaf of bread 4 can be moved in the direction of movement 8 of the loading compartment 2 towards the receiving compartment 3 by sliding against the wall 9 without catching on the edge 13 of the second part 11 of the wall 9. In a preferred embodiment of the invention, the wall 9 comprising said first part 10 and said second part 11 has a surface that is substantially flat.

When the loaf of bread 4 is sliced, it is advanced from the receiving compartment 3 to the loading compartment 2 in discrete steps of a distance corresponding to the thickness of a slice 14 to be cut. This is illustrated in FIGS. 9 and 10. The cutting member is then driven along the cutting plane 7 to cut successive slices 14 after each step of advancement of the loaf of bread 4.

In order, on the one hand, to ensure that the cut slices 14 are of good quality with a clean and even cut surface and, on the other hand, to allow unimpeded movement of the slices 14 towards the loading compartment 2, the chute has a widening immediately adjacent to the said second slot 12 on the side of the loading compartment 2.

At the location of this widening of the chute, the second part 11 of the wall 9 is connected to a guide surface 15 which extends between this first part 11 of the wall 9 and the second slot 12. This guide surface 15 forms a widening of the chute which allows to guide the loaf of bread 4 as it is moved from the receiving compartment 3 to the loading compartment 2.

In the embodiment of the slicer shown in FIGS. 1 to 14, a guide surface 15 extends between the first part 10 of the wall 9 and the cutting plane 5. This guide surface 15 is shown enlarged in FIG. 15. The guide surface 15 extends towards the outside of the chute, in particular the loading compartment 2, relative to the plane 16 of the wall 9. Thus, the distance between the plane 16 of the wall 9 and the guide surface 15 increases from the first part 10 of the wall 9 towards the cutting plane 5.

In general, this guide surface 15 is therefore inclined relative to the first part 10 of the wall 9, or relative to the plane 16 of this wall 9. Preferably, the guide surface 15 is in the form of a slat that is inclined relative to the plane 16 of the wall 9.

The guide surface 15 does not necessarily have to be straight, but may optionally have a curved shape. In this case, it is preferably slightly convex in the direction of movement 8 of the loaf of bread 4. A convex guide surface 15, in particular rounded towards the chute, is shown in FIG. 17.

When a loaf of bread 4 is to be sliced, the loaf is placed in the loading compartment 2, as shown in FIGS. 1 and 2. The loading compartment 2 has an access opening 17 for this purpose, which can be closed by a cover 18. In FIG. 2, the cover 18 is shown in its open position.

The slicer is equipped with a pusher 19 that can be driven in the direction of movement 8 of the loaf of bread 4. This pusher 19 can thus move between the receiving compartment 3 and the loading compartment 2. When the cover 18 is open, the pusher is located in the receiving compartment on the side opposite the cutting plane 5, as illustrated in FIGS. 1 and 2.

The pusher 19 comprises a retractable claw that allows a loaf of bread to be gripped for cutting. Thus, when the cover 18 is closed, the pusher is moved towards the loading compartment until it reaches the loaf of bread 4, which is gripped by the claw of the pusher 19, as shown in FIGS. 3 and 4. The pusher is then returned to the receiving compartment 3 through the cutting plane 5, while taking with it the loaf of bread 4, as illustrated in FIGS. 5 and 6.

After the uncut loaf of bread 4 has been moved to the receiving compartment 3 in this manner and is entirely within that compartment, as shown in FIGS. 7 and 8, the pusher then moves the loaf of bread 4 in discrete steps across the cutting plane 5 to return it to the loading compartment 2. During this last movement, the cutting member is driven and undergoes a back-and-forth movement along the cutting plane 5 in order to cut successive slices 14 of the loaf of bread as the loaf of bread 4 advances in the loading compartment 2. This is illustrated schematically in FIGS. 9 and 10.

The slicer, according to the invention, therefore comprises control means for actuating the pusher 19 in order to grasp the loaf of bread 4 in the loading compartment 2 and to move the bread 4 towards the receiving compartment 3 in said direction of movement 8. These control means also control the pusher 19 to return the loaf of bread 4 through the cutting plane 5 to the loading compartment, in cooperation with the cutting member to cut slices 14 from the loaf of bread 4 as it passes through the cutting plane 5.

To hold the cut slices 14 together, one against the other, the slicer includes a slice support 20 in the loading compartment. Such a slice support 20 is in itself known to the skilled person and is described, for example, in documents DE 20 2012 009 223 U, DE 10 2010 036 721, or EP 3 967 465.

In general, this slice support 20 is intended to exert a pressing force against the already cut portion of the loaf of bread 4 to hold the cut slices 14 against each other. The slice support 20 is movable and therefore moves as the cut portion of the loaf of bread 4 advances into the loading compartment 2 in order to maintain a slight pressure on the slices 14 to hold them together. This is shown schematically in FIGS. 9 and 11.

Once the loaf of bread 4 has been completely sliced, it is located in the loading compartment 2 and is released by the pusher claw 19 as shown in FIGS. 13 and 14. The pusher 19 then returns to its initial position, as shown in FIGS. 1 and 2, and the cover 18 can be opened by the user to retrieve the loaf of bread 4 cut into slices 14.

According to the embodiment of the invention shown in the figures, the support surface 6 for the loaf of bread 4 comprises a part 6a extending into the loading compartment 2 and a part 6b extending into the receiving compartment 3. These parts 6a and 6b are preferably aligned with each other at the location of the first slot 7 to allow the loaf of bread 4 to move on the support surface 6 between the two compartments 2 and 3 without being hindered by a difference in level between the two parts 6a and 6b of the support surface 6.

Interestingly, between the first part 6a of the support surface 6 and the first slot 7, a sliding surface 21 is present in the loading compartment 2. This sliding surface 21 is connected to the edge of the first part 6a of the support surface 6 facing the cutting plane 5. To facilitate the cutting of the slices 14 and the movement of the cut slices 14 towards the loading compartment 2, the sliding surface 21 extends in a recessed manner relative to the plane of the support surface 6.

This sliding surface 21 is, for example, in the form of a slat inclined relative to the support surface 6, which allows to guide the slices cut from the first slot 7 towards part 6a of the support surface 6. Possibly, this sliding surface 21 may be convex in the direction of movement 8 of the loaf of bread.

The presence of a sliding surface 21 is optional and may be omitted.

To optimize the cutting quality of the slices 14 and to make the slicer relatively compact, the support surface 6 may, for example, have an inclination a relative to the horizontal that is between 0° and 40° as shown in FIG. 2. Preferably, this inclination a is, for example, in the order of 25°. Thus, the loading compartment 2 is lower than the receiving compartment 3. The direction of movement 8 of the loaf of bread generally extends in a plane that is substantially transverse to the front of the user when the user places a loaf of bread in the loading compartment 2, so that the loaf of bread moves toward the user when the loaf of bread is sliced.

To ensure that the loaf of bread 4 is always guided correctly by the wall 9 and along the wall 9 before being cut in slices 14, the support surface 6 preferably has an inclination relative to the horizontal of between 0° and 45°, and, for example, greater than 10°, in a direction extending transversely to the direction of movement 8 of the loaf of bread 4.

In a variant embodiment of the machine according to the invention, the second part 11 of the wall 9 extending into the receiving compartment 3 has an edge 13 that is directed towards the second slot 12. This edge has a chamfer or a rounded edge on the side of the chute to facilitate the movement of the loaf of bread 4 from the loading compartment 2 to the receiving compartment 3. This is shown schematically in FIG. 16. This edge 13 extends substantially parallel to the cutting plane 5.

The presence of the guide surface 15, preferably in combination with the feature that the surfaces of the first part 10 of the wall 9 and the second part 11 of this wall 9 are aligned at the location of the second slot 12, allows a loaf of bread to be moved in the direction of movement 8 through this slot between compartments 2 and 3 without catching on the edges of this slot 12. Thus, the loaf of bread can be easily moved in the direction of movement 8, on the one hand, from the loading compartment 2 to the receiving compartment 3, and, on the other hand, in the same direction of movement 8 in the opposite sense from the receiving compartment 3 to the loading compartment 2.

1. A bread slicer for cutting a loaf of bread into slices, comprising:
a loading compartment which is connected to a receiving compartment, said compartments defining a chute for moving the loaf of bread
a cutting member movable along a cutting plane and enabling slices to be cut from the loaf of bread when the loaf of bread is moved between the loading compartment and the receiving compartment along the chute,
a support surface for the loaf of bread this surface extending in the aforementioned compartments along the chute and having a first slot between said compartments to allow the cutting member to pass through along said cutting plane, this support surface defining a direction of movement of the loaf of bread parallel to the support surface and substantially transversely to said first slot,
a side wall for said chute, said wall extending along said direction of movement with a first part of the wall extending along the loading compartment and a second part of the wall extending along the receiving compartment, this wall having a second slot between the compartments to allow the cutting member to pass through along said cutting plane, this second slot being connected to the first slot,
wherein, at least at the location of the second slot, the second part of the wall extends in line with the first part of this wall, and the first part of the wall is connected to a guide surface which extends between this first part of the wall and the second slot so that the guide surface forms a widening of the chute which guides the loaf of bread as the loaf of bread moves from the receiving compartment to the loading compartment.

2. The slicer according to claim 1, wherein said wall extends substantially transversely with respect to the support surface.

3. The slicer according to claim 1, wherein said guide surface is inclined relative to the plane of the first part of the wall.

4. The slicer according to claim 1, wherein the guide surface is in the form of a slat inclined relative to the plane of the wall.

5. The slicer according to claim 1, wherein the guide surface is convex in said direction of movement of the loaf of bread.

6. The slicer according to claim 1, in which said wall comprising said first part and said second part of this wall, has a surface that is substantially flat.

7. The slicer according to claim 1, with a movable pusher capable of moving in said direction of movement of the loaf of bread which allows the loaf of bread to be gripped and moved between said compartments through the cutting plane.

8. The slicer according to claim 7, with control means for actuating the pusher to grasp a loaf of bread in the loading compartment and to move the loaf of bread toward the receiving compartment in said direction of movement of the loaf of bread and, subsequently, to return the loaf of bread through the cutting plane to the loading compartment to cut the loaf of bread into slices.

9. The slicer according to claim 1, wherein the support surface for the loaf of bread comprises a portion extending into the loading compartment and a portion extending into the receiving compartment these parts being aligned with each other at the location of the first slot, wherein between the first part of the support surface and the first slot, a sliding surface is present in the loading compartment which connects to the edge of the first part facing the cutting plane and which is recessed relative to the plane of the support surface.

10. The slicer according to claim 9, wherein the sliding surface is in the form of a slat inclined relative to the support surface.

11. The slicer according to claim 9, wherein the sliding surface is convex in said direction of movement of the loaf of bread.

12. The slicer according to claim 1, wherein said support surface has an inclination (a) relative to the horizontal of between 0° and 40°, and preferably in the order of 25°, in the direction of movement (8) of the loaf of bread so that the loading compartment is lower than the receiving compartment

13. The slicer according to claim 1, wherein the support surface has an inclination relative to the horizontal of between 0° and 45°, and preferably greater than 10°, in a direction extending transversely to the direction of movement of the loaf of bread.

14. The slicer according to claim 1, comprising an access opening for the loading compartment for placing a loaf of bread to be sliced in this compartment.

15. The slicer according to claim 1, comprising a slice support extending into the loading compartment, this support being intended to exert a pressure force against the already cut portion of the loaf of bread to hold the slices of the loaf of bread against each other, the slice support being movable to maintain the support in contact with the cut portion of the loaf of bread as this cut portion advances in the loading compartment.

16. The slicer according to claim 1, wherein the part of the wall extending into the receiving compartment has an edge which is directed towards the second slot this edge being provided with a chamfer or a rounding on the side of the chute to facilitate the movement of the loaf of bread from the loading compartment to the receiving compartment.

17. The slicer according to claim 16, wherein said edge extends substantially parallel to the cutting plane.
